(19) United States
(12) Patent Application Publication
(10) Pub. No.: US 2012/0073507 A1
(43) Pub. Date: Mar. 29, 2012

(54) Apparatus for Holding and Disposing of Animal Wastes

(76) Inventor: Joel Anderson, Blythe, CA (US)

(21) Appl. No.: 12/889,828

(22) Filed: Sep. 24, 2010

(51) Int. Cl. A01K 29/00

(52) U.S. Cl. 119/161

(57) ABSTRACT

An apparatus includes a frame operable for holding and disposing of animal wastes. The frame has a central aperture. A grass-like material covers an interior surface of the frame, wherein at least a portion of the grass-like material extends over a side of the frame to be operable as a ramp for entry into the frame. A grid is joined to the central aperture for protecting the central aperture and. A plurality of water jets is disposed about an interior perimeter of the frame for directing overlapping jets of water to wash the animal wastes to the central aperture. A water line supplies water to the water jets. The water line is operable for automatically controlling a flow of water to the water jets. A solar powered sensor is operable for activating an automatic flushing. A sewer line is joined to the central aperture for receiving the washed animal waste.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to an animal waste disposal system. More particularly, the present invention relates to an open outdoor animal waste disposal system attached to a sewer pipe.

### BACKGROUND OF THE INVENTION

Outdoor animal waste is always an unpleasant thing, whether it is from a dog, a cat or a wild animal. Sanitation and potential health problems can quickly occur when animal waste, particularly feces, is not promptly properly disposed of Picking-up feces with a shovel or by hand is very unpleasant and unhygienic and is often placed in a garbage can for improper disposal. Neighbors can also complain about the odor from unattended animal or pet feces, even when it is not in their own yard. A pet can also suffer from hygienic and health related problems when feces is left for an extended period of time unattended to and not properly disposed of.

In view of the foregoing, what is needed is an animal waste disposal system. It would be desirable if at least some of the foregoing limitations of the prior art are overcome for animal waste disposal systems. It is further desirable that an animal waste disposal system is outdoors, is tied directly into a sewer pipe for proper disposal, is easy to train a dog or other pet how to use and be aesthetically pleasing.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates an overhead side environmental representation of an exemplary embodiment of the present invention.

FIG. 1B illustrates an overhead front representation of an exemplary embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for holding and disposing a variety of animal wastes is presented, techniques are described.

In one embodiment an apparatus includes means for holding and disposing of animal wastes, means for directing overlapping jets of water to wash the animal wastes to a central aperture, means for supplying water to the water jets, and means for receiving the washed animal waste.

In another embodiment an apparatus includes a frame operable for holding and disposing of animal wastes, and for securing to an area of ground. The frame includes a central aperture. A plurality of water jets is disposed about an interior perimeter of the frame for directing overlapping jets of water to wash the animal wastes to the central aperture. A water line supplies water to the water jets. The water line is operable for automatically controlling a flow of water to the water jets. A sewer line is joined to the central aperture for receiving the washed animal waste.

In another embodiment an apparatus includes a frame operable for holding and disposing of animal wastes, and for securing to an area of ground. The frame comprising a central aperture. A plurality of eyelets is disposed about an outside perimeter of the frame for securing the frame to the ground. A grass-like material covers an interior surface of the frame, wherein at least a portion of the grass-like material extends over a side of the frame to be operable as a ramp for entry into the frame. A grid is joined to the central aperture for protecting the central aperture and for mitigating entry of large objects. The grid has a dome structure. A plurality of water jets is disposed about an interior perimeter of the frame for directing overlapping jets of water to wash the animal wastes to the central aperture. A water line supplies water to the water jets. The water line is operable for automatically controlling a flow of water to the water jets, wherein the water line further comprises a shut-off valve. A solar powered sensor is operable for activating an automatic flushing. Means joins a decorative structure to the frame. A sewer line is joined to the central aperture for receiving the washed animal waste, wherein the sewer line further comprises a trap.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Some preferred embodiments of the present invention provide means and methods for providing an animal waste disposal system. Animal waste disposal system utilizes a frame that is designed to hold and dispose of animal feces and urine and is made of Fiberglass™. Frame will be set on a ground surface and includes a detachable tree that can be detached for packing purposes. Frame is provided with a multiplicity of eyes on side of frame to accommodate a multiplicity of stakes that are driven into ground to stabilize and secure frame to ground. Frame will have a multiplicity of water jets around its perimeter to wash down deposited animal feces and urine through a disposal aperture and a grid and into a sewer line. Disposal aperture and grid are disposed in the center of frame to receive washed down feces and urine. Sensors are provided to activate an automatic flushing capability when feces or urine is detected on frame. The sensor assembly is powered by a solar cell that will harvest power from outdoor light. There will be no handles to trip or buttons to push. The sensor will adapt to its surroundings, once the dog enters the sensor range and then step away, the solenoid in the automatic flush valves will cycle.

A preferred embodiment of the present invention, and at least some variations thereof, includes a grass-like surface provided on the surface of frame. Grass-like surface can also be placed over perimeter of frame to act as a ramp for an animal to crawl over and walk onto surface of frame.

A preferred embodiment of the present invention, and at least some variations thereof, include water jets overlapping each other to ensure that water is sprayed over entire frame to wash down feces or urine found anywhere within frame. Water is provided to water jets through perimeter sides of the frame by a water line. Perimeter sides are flared for safety. Water line is made of PVC material and is buried underground. Water jets provide a self-crossing jet water flow for better washing capability. Water line includes a flushing sensor that automatically runs water and washes down feces and urine when detected on surface of frame. The flushing sensor valve will connect within the body of the unit once the user enters, The sensor act according after the user leave area. The autoflush also has a battery backup. Water can also be used from an exterior source, such as a hose, to wash down feces and urine into disposal aperture and grid. A shut-off valve is provided to shut-off water flow from water line if needed.

A preferred embodiment of the present invention, and at least some variations thereof, includes a sewer line provided with a p trap to stop the sewer gas from returning back up through sewer line. Sewer line is made of ABS schedule 40 material and is buried underground. All sewer pipe underground is either CLAY or CAST IRON or ABS. Schedule 40 is the thickness. Sewer line is provided with a sewage cleanout and runs directly into a main sewer line.

A preferred embodiment of the present invention, and at least some variations thereof, include frame directly connected to a rest area sewer line or a park sewer line.

One aspect of the present invention is the identifying and solving problems attendant to prior art approaches to discover approaches that provide an animal waste disposal system.

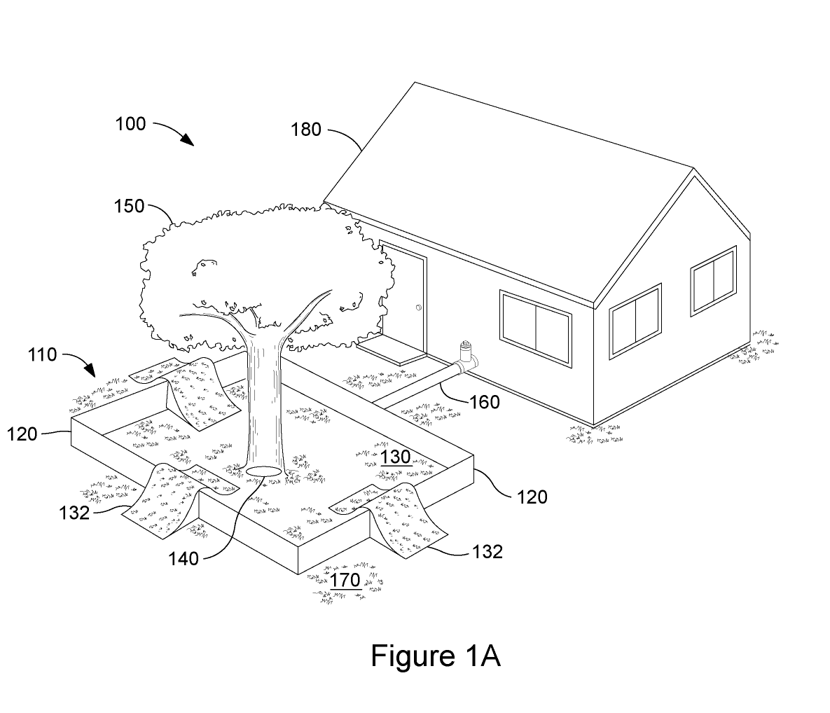

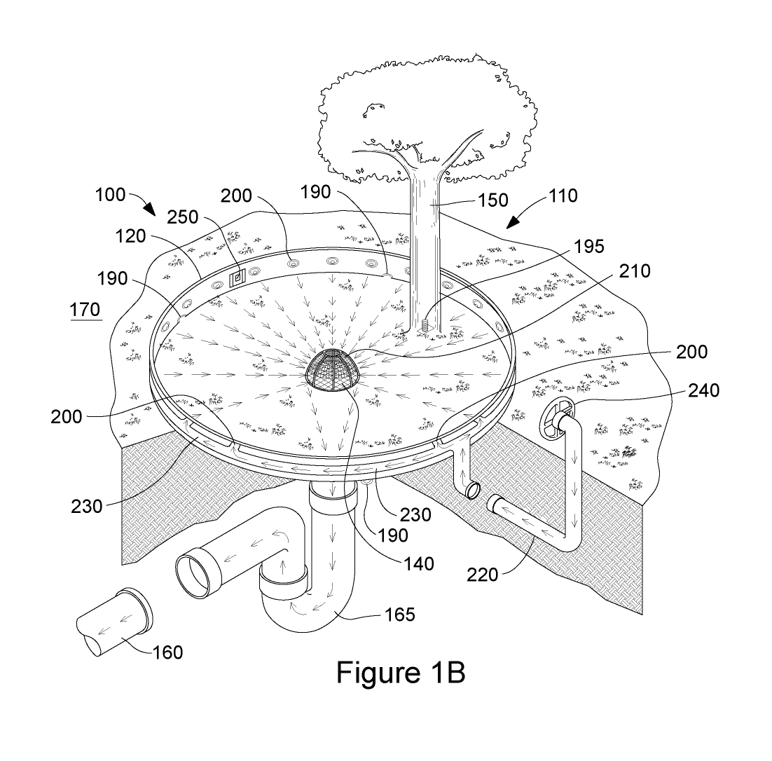

FIG. 1A illustrates an overhead side environmental representation of an exemplary embodiment of the present invention.

An animal waste system 100 includes a frame 110, a side perimeter 120, a grass-like surface 130, a disposal aperture 140, a detachable tree 150, a sewer line 160, a ground surface 170 and a house 180.

As viewed in FIG. 1A, frame 110 includes side perimeter 120 that encases a grass-like surface 130. Grass-like surface 130 can also be placed over side perimeter 120 to act as a ramp 132 for an animal to crawl over and walk onto surface of frame. Frame 110 is also made of Fiberglass™ material. A thick plastic with a NON Slippery bottom or LIGHT WEIGHT CONCRET. Sensors (not shown) are provided to activate an automatic flushing capability when feces or urine is detected on frame The sensor assembly is powered by a solar cell that will harvest power from LIGHT with BATTERY BACKUP to power the automatic flush valve, which will be connected to the WATER LINE SORCE. 110

Disposal aperture 140 is disposed in the approximate middle of frame 110 and receives animal feces and urine that are washed into it. Disposal aperture 140 is directly connected to sewer line 160 where animal feces and urine are further taken away from frame 110.

Detachable tree 150 is provided for aesthetic purposes and can be removed for ease of packing purposes. Sewer line 160 is also provided with a ptrap 165 to stop sewer gas from returning back up through sewer line. Sewer line 160 receives animal feces from disposal aperture 140 and runs directly into house 180. Sewer line 160 is made of ABS schedule 40 material and is buried underground. All sewer pipe underground is either CLAY or CAST IRON or ABS. Schedule 40 is the thickness. Frame 110 can also be placed on any ground surface 170 that can access sewer line 160. Frame 110 can also be directly connected to a rest area sewer line or a park sewer line provided in a rest area or park (not shown).

FIG. 1B illustrates an overhead front representation of an exemplary embodiment of the present invention.

As viewed in FIG. 1B, frame 110 is provided with a multiplicity of eyes 190 disposed on side of frame 110 to accommodate a multiplicity of stakes (not shown) that can be driven into ground surface 170 to stabilize and secure frame 110 to ground surface 170. An attachment screw 195 is also provided to attach detachable tree 150 to frame 110.

A multiplicity of water jets 200 are disposed inside the side perimeter 120 and spray water into frame 110 to move and wash away feces and urine that are deposited by an animal using the animal waste system 100. Multiplicity of water jets 200 provide a self-crossing water flow for better washing capability. Animal feces and urine are washed into disposal aperture 140 which is protected with a grid 210 that also serves to prevent large clumps of animal waste from clogging disposal aperture 140. Animal feces and urine then go into sewer line 160 where it is then moved further away from frame 110.

A water line 220 is provided which directs water into a channel 230 disposed inside side perimeter 120. Channel 230 directs water directly to multiplicity of water jets 200 to wash down animal feces and urine. Water line 220 is made of PVC material and is buried underground. Standard water line is PVC. Water line 220 includes a flushing sensor (not shown) that automatically runs water and washes down feces and urine when detected on surface of frame. The flushing sensor valve will connect within the body of the unit once the user enters, The sensor act according after the user leave area. The autoflush also has a battery backup. Water line 220 also includes a shut-off valve 240 to shut-off water flow from water line 220 if needed. Solar light sensor 250 is provided to activate an automatic flushing capability when feces or urine is detected on frame. The sensor assembly 250 is powered by a solar cell that will harvest power from outdoor light. There will be no handles to trip or buttons to push. The sensor will adapt to its surroundings, once the dog enters the sensor range and then step away, the solenoid in the automatic flush valves will cycle.

Those skilled in the art, in light of the teachings of the present invention, will readily recognize how to adapt and configure at least some embodiments of present invention to effectively provide utility to water being used from an exterior source, such as a hose, to wash down feces and urine into disposal aperture 140 and grid 210.

Those skilled in the art, in light of the teachings of the present invention, will readily recognize how to adapt and configure at least some embodiments of present invention to effectively provide utility to using surfaces or no surface on frame 110 other than grass-like surface 130 and ramps 132.

Those skilled in the art, in light of the teachings of the present invention, will readily recognize how to adapt and configure at least some embodiments of present invention to effectively provide utility to the following applications:

Use by home owners

Use by home builders

Use in airports

Use in animal shelters

Use by private property owners

Use in parks

Use in rest areas

Sold in hardware and building supply stores

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicants hereby give notice that new claims may be formulated to such features and/or combinations of such features during the prosecution of the present application or of any further application derived therefrom.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Having fully described at least one embodiment of the present invention, other equivalent or alternative methods of using an animal waste disposal system according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
means for holding and disposing of animal wastes;
means for directing overlapping jets of water to wash the animal wastes to a central aperture;
means for supplying water to the water jets; and
means for receiving the washed animal waste.

2. The apparatus as recited in claim 1, further comprising means for protecting the central aperture and for mitigating entry of large objects.

3. The apparatus as recited in claim 1, further comprising means for securing the holding and disposing means to the ground.

4. The apparatus as recited in claim 1, further comprising means operable for activating an automatic flushing.

5. The apparatus as recited in claim 1, further comprising means for covering an interior surface of the frame.

6. The apparatus as recited in claim 1, further comprising means for joining a decorative structure to the frame.

7. An apparatus comprising:
a frame operable for holding and disposing of animal wastes, and for securing to an area of ground, the frame comprising a central aperture;
a plurality of water jets disposed about an interior perimeter of the frame for directing overlapping jets of water to wash the animal wastes to the central aperture;
a water line for supplying water to the water jets, the water line being operable for automatically controlling a flow of water to the water jets; and
a sewer line joined to the central aperture for receiving the washed animal waste.

8. The apparatus as recited in claim 7, further comprising a grid joined to the central aperture for protecting the central aperture and for mitigating entry of large objects.

9. The apparatus as recited in claim 7, further comprising a plurality of eyelets disposed about an outside perimeter of the frame for securing the frame to the ground.

10. The apparatus as recited in claim 7, further comprising a solar powered sensor operable for activating an automatic flushing.

11. The apparatus as recited in claim 7, further comprising a grass-like material for covering an interior surface of the frame.

12. The apparatus as recited in claim 11, wherein at least a portion of the grass-like material extends over a side of the frame to be operable as a ramp for entry into the frame.

13. The apparatus as recited in claim 7, further comprising means for joining a decorative structure to the frame.

14. The apparatus as recited in claim 13, wherein the decorative structure is a tree.

15. The apparatus as recited in claim 7, wherein the water line further comprises a shut-off valve.

16. The apparatus as recited in claim 7, wherein the sewer line further comprises a trap.

17. The apparatus as recited in claim 7, wherein the grid further comprises a dome structure.

18. The apparatus as recited in claim 7, wherein the water line and the sewer line are buried below the ground.

19. An apparatus comprising:
a frame operable for holding and disposing of animal wastes, and for securing to an area of ground, the frame comprising a central aperture;
a plurality of eyelets disposed about an outside perimeter of the frame for securing the frame to the ground;
a grass-like material for covering an interior surface of the frame, wherein at least a portion of the grass-like material extends over a side of the frame to be operable as a ramp for entry into the frame;
a grid joined to the central aperture for protecting the central aperture and for mitigating entry of large objects, the grid having a dome structure;
a plurality of water jets disposed about an interior perimeter of the frame for directing overlapping jets of water to wash the animal wastes to the central aperture;
a water line for supplying water to the water jets, the water line being operable for automatically controlling a flow of water to the water jets, wherein the water line further comprises a shut-off valve;
a solar powered sensor operable for activating an automatic flushing;
means for joining a decorative structure to the frame; and
a sewer line joined to the central aperture for receiving the washed animal waste, wherein the sewer line further comprises a trap.

20. The apparatus as recited in claim 19, wherein the decorative structure is a tree.
